(19) United States
(12) Patent Application Publication
(10) Pub. No.: US 2002/0176906 A1
(43) Pub. Date: Nov. 28, 2002

(54) Injection molding apparatus for seal member

(75) Inventors: Hiroyuki Kinugawa, Tokyo (JP); Youji Udagawa, Tokyo (JP); Tomoyuki Nakaya, Tokyo (JP)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: MITSUBISHI DENKI KABUSHIKI KAISHA

(21) Appl. No.: 09/964,694

(22) Filed: Sep. 28, 2001

(30) Foreign Application Priority Data
May 7, 2001 (JP) 2001-136637

(51) Int. Cl. B29C 45/38

(52) U.S. Cl. 425/556; 425/292

(57) ABSTRACT

The invention provides an injection molding apparatus for seal member in which a seal member being a molding is left on the moving side without fail when opening a stationary mold and a moving mold. In the injection molding apparatus for seal member according to the invention, a molten resin is injected by way of a gate 59 into a cavity 58, the injected molten resin is cut by a gate seal pin 66 provided on the moving side while sealing the gate, and under the condition that the moving mold is opened from the stationary mold, a seal member 35 remaining in the moving side is ejected by ejector pins 68 provided on the moving side, thus the seal member 35 is molded; wherein on the moving mold 54, convex portions for forming recesses of wall thickness is formed at portions not serving as sealing faces of the seal member 35.

### BACKGROUND OF THE INVENTION

1. Technical Field

The present invention relates to an injection molding apparatus for seal member used in, for example, valve timing adjustment device.

2. Background Art

FIG. 11 is a sectional view showing a conventional injection molding apparatus, disclosed in the Japanese Patent Publication (unexamined) No. 225975/1997. In the drawing, reference numeral 1 is an injection molding apparatus, numeral 2 is a mold carried on a moving platen (hereinafter referred to as moving mold 2), and numeral 3 is a mold carried on a stationary platen (hereinafter referred to as stationary mold 3). Numeral 4 is an ejector plate, numeral 5 is an ejector pin, numeral 6 is a gate seal pin, numeral 7 is a hydraulic cylinder, and numeral 8 is a molding. The injection molding apparatus 1 is comprised of the moving mold 2 moving slidably backward and forward and the stationary mold 3. (The backward direction is defined as the upward direction in the Figure, and the forward direction is defined as the downward direction in the Figure, hereinafter. ) A moving platen 10 is mounted on the moving mold 2 by interposing a spacer 9 therebetween. The ejector plate 4 is provided inside the spacer 9, and the plurality of ejector pins 5 are provided projecting on the ejector plate 4 and through the moving mold 2. The ejector plate 4 is moved slidably by means of a sliding mechanism, thereby the ejector pins 5 come to move back and forth.

Further, the moving mold 2 is provided with the gate seal pin 6 actuated by the hydraulic cylinder 7. The gate seal pin 6 is placed at a position where a gate 11 is open until the time immediately before resin is injected. Immediately after the resin is injected, however, the gate seal pin 6 is ejected toward the stationary mold 3 by means of the hydraulic cylinder 7, and cuts the resin while sealing the gate 11.

The stationary mold 3 is provided with a cavity recessed on a mold-carrying face being mated with the moving mold 2 together. On the opposite side of the mold-carrying face, there is provided a stationary bottom plate 13 provided with an injection port 12 for a molten resin and a runner stripper plate 14. A nozzle of the injection molding apparatus is put in contact with the injection port 12, then the fed resin is charged into the cavity 8 passing through a runner 15 and the gate 11. In the construction of this injection molding apparatus 1, the stationary mold 3, the runner stripper plate 14 and the stationary bottom plate 13 forma stationary side, while the moving mold 2, the spacer 9 and movable bottom plate 10 comprise a movable side.

Molding process is now described. First by moving forward the moving mold 2 of the injection molding apparatus 1 and mating the moving mold 2 and the stationary mold 3 together, thereby the two molds being closed, and a molten resin is injected from the injection port 12 of the stationary bottom plate 13. After charging the cavity 8 with the injected resin, the hydraulic cylinder 7 is actuated to move the gate seal pin 6 forward. Thus the resin located at the end of the gate seal pin 6 is forcedly pushed and cut while sealing the gate 11. Subsequently, after cooling down the injected resin, the molds are opened by moving the moving mold 2 backward. When moving the ejector plate 4 toward the stationary mold 3, the ejector pins 5 eject a molding 8 just having been molded and the gate seal pin 6, and the ejector pin 5 ejects the gate 11. As a result, it is possible to take out the molding 8 separated from the gate 11.

In the mentioned conventional type of injection molding apparatus 1 wherein the ejector pins 5 are arranged on the moving side, when opening the molds by moving the moving mold 2 backward, the molding 8 is left on the moving side and ejected by the ejector pins 5. When opening the mold, however, if the molding 8 should remain in the stationary side contrary to our expectation, a problem exists in that it is impossible to eject the molding 8 by the ejector pins 5, making it impossible to perform continuous production, eventually resulting in deterioration in productivity.

### SUMMARY OF THE INVENTION

The present invention was made to solve the above-discussed problem and has an object of providing an injection molding apparatus for seal member in which a seal member being a molding is left on the moving side without fail when opening a stationary mold and a moving mold.

To accomplish the foregoing object, the invention provides an injection molding apparatus for seal member in which a molten resin is injected by way of a gate into a cavity formed by mating a moving mold with a stationary mold; the injected resin is cut by means of a gate seal pin provided on the moving side while sealing the gate; and a seal member left on the movable side is ejected by means of a plurality of ejector pins provided on the moving side under a condition of opening the mentioned moving mold from the mentioned stationary mold, thereby molding the seal member; the injection molding apparatus being provided with defined convex portions on the mentioned moving mold and the defined convex portions forming recesses of wall thickness at portions not serving as sealing faces of the seal member.

In the injection molding apparatus for seal member of above construction according to the invention, the injection molding apparatus is provided with defined convex portions on the mentioned moving mold and those defined convex portions form recesses of wall thickness at portions not serving as sealing faces of the seal member. As a result, when opening the moving mold from the stationary mold, the seal member being a molding is left on the moving side without fail.

The invention also provides another injection molding apparatus for seal member in which a molten resin is injected by way of a gate into a cavity formed by mating a moving mold with a stationary mold; the injected resin is cut by means of a gate seal pin provided on the moving side while sealing the gate; and a seal member left on the movable side is ejected by means of a plurality of ejector pins provided on the moving side under a condition of opening the mentioned moving mold from the mentioned stationary mold, thereby molding the seal member; the injection molding apparatus being provided with defined concave portions on the mentioned moving mold and the defined concave portions forming ribs at portions not serving as sealing faces of the seal member.

In the injection molding apparatus for seal member of above construction according to the invention, the injection molding apparatus is provided with defined concave portions on the mentioned moving mold and those defined concave portions form recesses of wall thickness at portions not serving as sealing faces of the seal member. As a result, when opening the moving mold from the stationary mold, the seal member being a molding is left on the moving side without fail.

It is also preferable that ejecting position of the ejector pins is adapted to come to the portions not serving as sealing faces of the seal member.

In the injection molding apparatus for seal member of above construction according to the invention, ejecting position of the ejector pins is adapted to come to the portions not serving as sealing faces of the seal member. As a result, there is no possibility that any trace of irregularity remains on the sealing faces.

It is also preferable that the gate seal pin performs a function of ejecting the seal member left on the moving side in cooperation with the ejector pins, and ejecting position of the gate seal pin is adapted to come to the portions not serving as sealing faces of the seal member.

In the injection molding apparatus for seal member of above construction according to the invention, the gate seal pin performs a function of ejecting the seal member left on the moving side in cooperation with the ejector pins, and ejecting position of the gate seal pin is adapted to come to the portions not serving as sealing faces of the seal member. As a result, there arises no problem of damaging the sealing faces.

It is also preferable that the seal member is adapted to be used in valve timing adjustment devices.

In the injection molding apparatus for seal member of above construction according to the invention, the seal member is adapted for use in valve timing adjustment devices. As a result, it is possible to obtain a suitable seal member having sealing faces with sufficient accuracy.

### BRIEF DESCRIPTION OF THE DRAWINGS

FIGS. 1 is a sectional view showing an injection molding apparatus for seal member according to Embodiment 1 of the present invention, and is a sectional view taken along the lines I-I of FIG. 2.

FIG. 2 is a plan view of top of FIG. 1.

FIG. 3 is a sectional view at the time of opening the molds of the injection molding apparatus for seal member shown in FIG. 1.

FIGS. 4(a), (b) and (c) are explanatory views each to explain an arrangement of a gate.

FIGS. 5(a) and (b) are explanatory view each to explain how to prevent a molding from being taken by a cavity at the time of opening the molds.

FIG. 6 is a sectional view taken along the lines VI-VI of FIG. 7 showing a general type of valve timing adjustment device.

FIG. 7 is a sectional view taken along the lines VII-VII of FIG. 6 showing a general type of valve timing adjustment device.

FIG. 8 is a partially perspective view of a case having a shoe. FIG. 9 is a perspective view showing a seal member for a valve timing adjustment device according to the invention and a plate spring for energizing the seal member.

FIGS. 10(a), (b) and (c) are explanatory views each showing a construction of a cavity of the injection molding apparatus for seal member according to Embodiment 2 of the invention, and each of these views corresponds to FIGS. 4(a), (b) and (c) showing Embodiment 1 of the invention.

FIG. 11 is a sectional view of a conventional injection molding apparatus.

### DESCRIPTION OF THE PREFERRED EMBODIMENTS

Embodiment 1

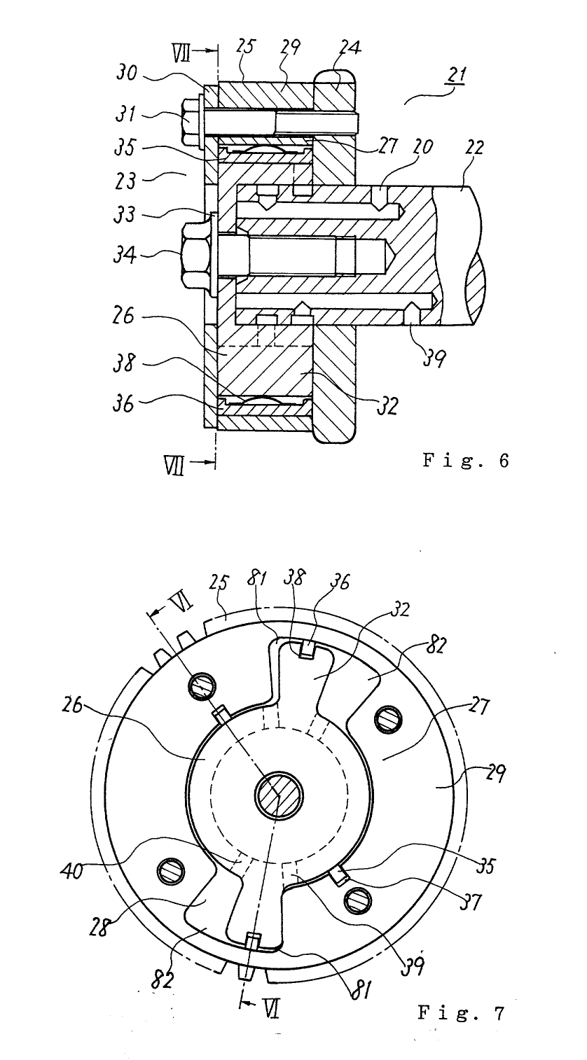

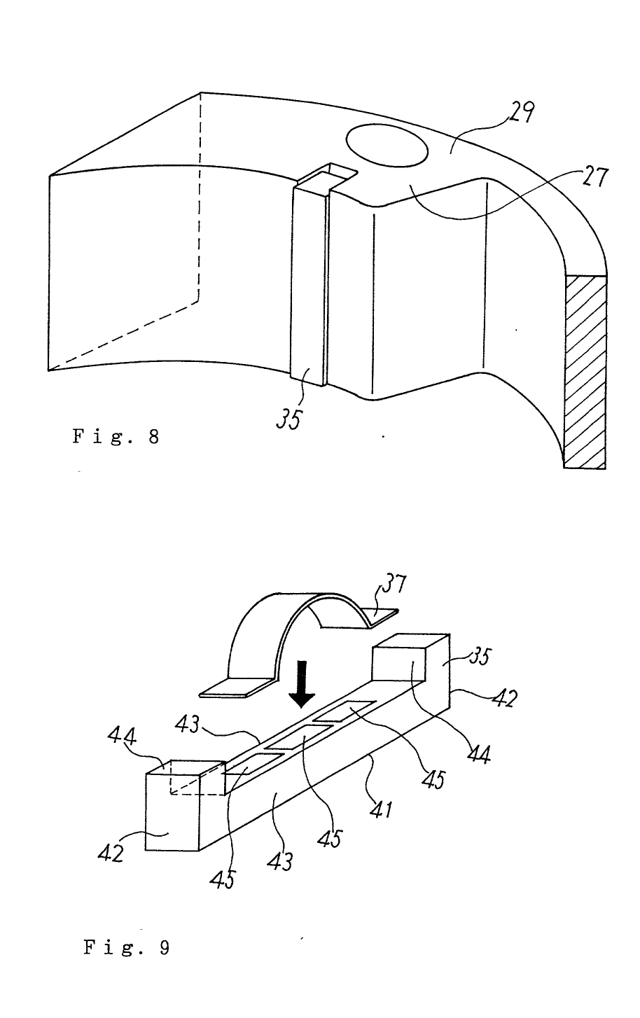

FIG. 6 is a sectional view taken along the lines VI-VI of FIG. 7 showing a general type of valve timing adjustment device, and FIG. 307 is a sectional view taken along the lines VII-VII of FIG. 6. A valve timing adjustment device 21 is provided with a phase changing mechanism 23 mounted on a camshaft 22. A sprocket 24 is rotatably mounted on the camshaft 22, and a plurality of external teeth is formed on periphery portion of the sprocket 24. The external teeth of the sprocket 24 and a crank pulley of a crankshaft (not shown) are hooked by a timing chain. As a result, rotation of the sprocket 24 and that of the crankshaft are synchronized.

The phase changing mechanism 23 is provided with a substantially hollow housing 25 and a rotor 26 that is inserted in the housing 25 so as to be rotatable relative to the housing 25 only within a range of predetermined angle. The housing 25 is comprised of the sprocket 24, a case 29 having, and a cover 30 by securing these members with a bolt 31. The case 29 has, for example, two shoes 27 projecting inwardly in radial direction and forms two hydraulic chambers 28 between the two shoes 27. The housing 25 thus formed rotates integrally with the sprocket 24 in one piece. The rotor 26 includes two vanes 32 projecting outwardly in radial direction, and two hydraulic chambers 28 are divided into first hydraulic chambers (advance angle chambers) 81 and second hydraulic chambers (delay angle chambers) 82 respectively by the mentioned two vanes and the mentioned two shoes 27. The rotor 26 is fixed securely to the camshaft 22 with a bolt 34 having a flange 33, being rotatable relative to the housing 25 within a range of predetermined angle, and rotates integrally with the camshaft 22 in one piece together with the housing 25.

To prevent oil leakage from between the first hydraulic chambers 81 and the second hydraulic chambers 82, seal members 35, 36 and plate springs 37, 38 for energizing the seal members are disposed within slits formed axially at the end portions of each shoe 27 and each vane 32.

The housing 25 rotates synchronously with the crankshaft. Therefore it may be said that the rotation of the rotor 26 is relative not only to the housing 25 but also to the crankshaft. Accordingly, it is possible to change rotation phase of the camshaft 22 in relation to the crankshaft by adjusting position of the rotor 26 in relation to the housing 25, namely by adjusting dimensions of the first hydraulic chambers 81 and the second hydraulic chambers 82. Change in rotation phase in this manner can be conducted by supplying or discharging oil to or from a first oil passage 39 and a second oil passage 40 communicating respectively to the first hydraulic chamber 81 and the second hydraulic chamber 82.

As described above, the seal members 35, 36 disposed in the slits formed in axial direction, at the end portions of each shoe 27 and each vane 32 are intended to prevent oil leakage between the first hydraulic chamber 81 and the second hydraulic chamber 82. Therefore, flatness of the sealing surfaces is essentially required. FIG. 8 is a partially perspective view of a case 29 having the shoe 27, and FIG. 9 is a perspective view showing a seal member for valve timing adjustment device molded according to the invention and a plate spring that energizes the seal member.

In the seal member 35 (likewise in the seal member 36) for valve timing adjustment device, a sliding face 41 positioned inwardly in radial direction of the valve timing adjustment device (a sliding face positioned outwardly in radial direction in case of the sliding member 36), sliding faces 42 positioned at both ends in axial direction, and faces 43 for contacting the slit are respectively used as sealing faces, and therefore flatness of these portions is essentially required. In this sense, it is not desirable to arrange a gate for injecting a molten resin, traces of ejector pins, mold splitting, etc. on these sealing faces from the viewpoint of preventing negative affection on the flatness. The plate spring 37 (38) that energizes the seal member 35 in radial direction is disposed on the opposite face of the sliding face 41 positioned in radial direction. At both ends of the face there are disposed projections 44 that restrict movement of the plate spring 37 in axial direction. Furthermore, in the middle part of the face, recesses of wall thickness 45 (concave portions) are provided in order to increase sliding resistance between the seal member and the moving mold.

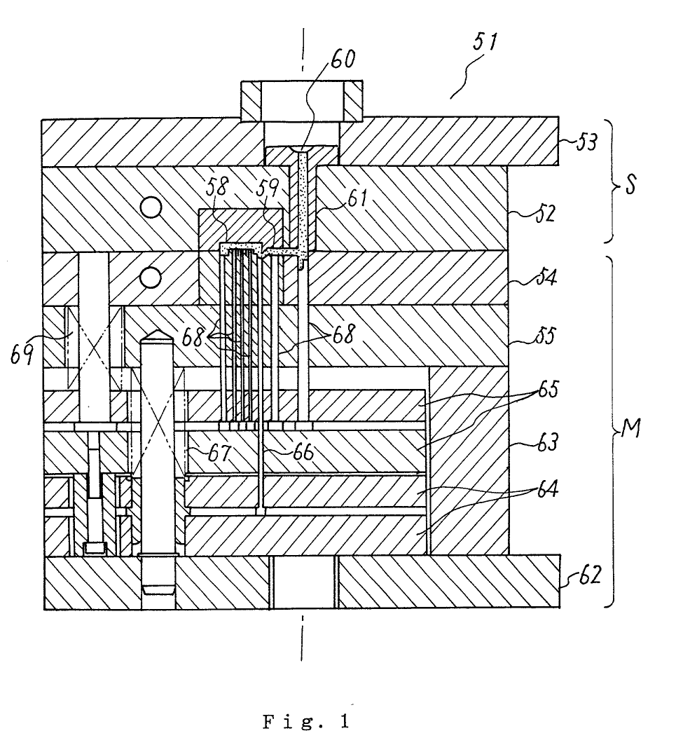

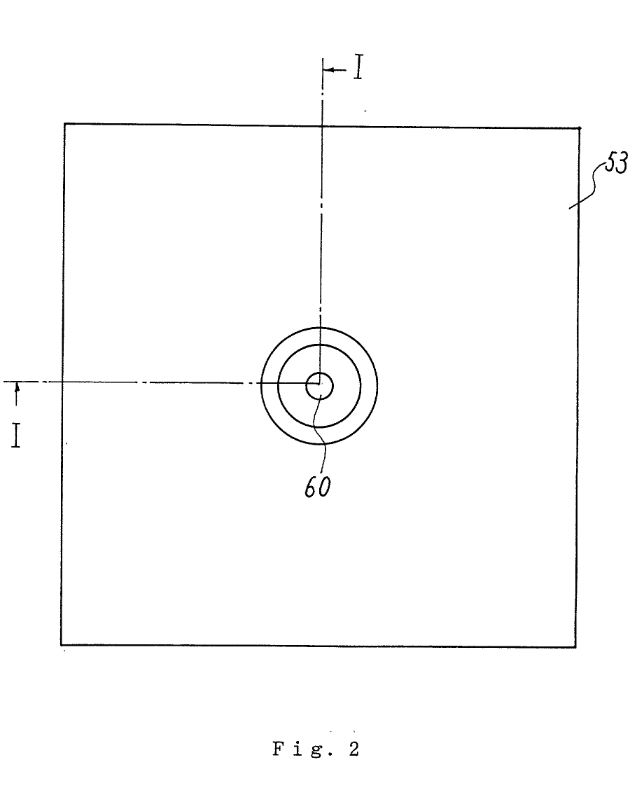

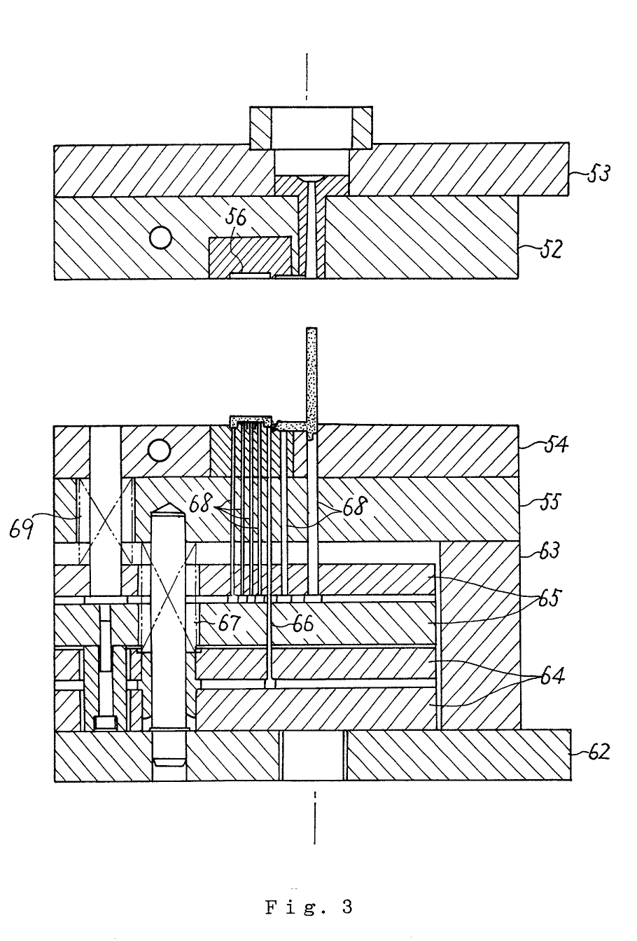

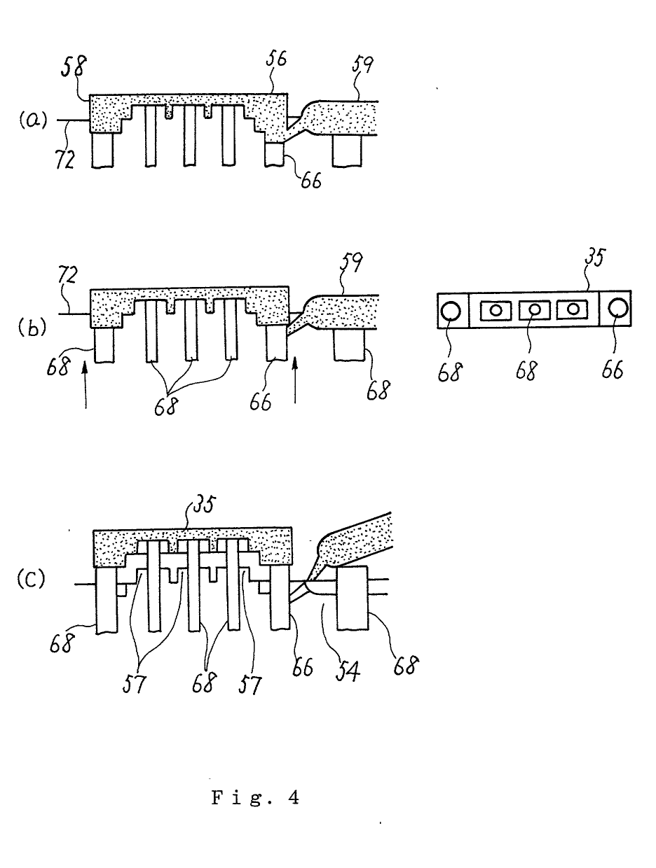

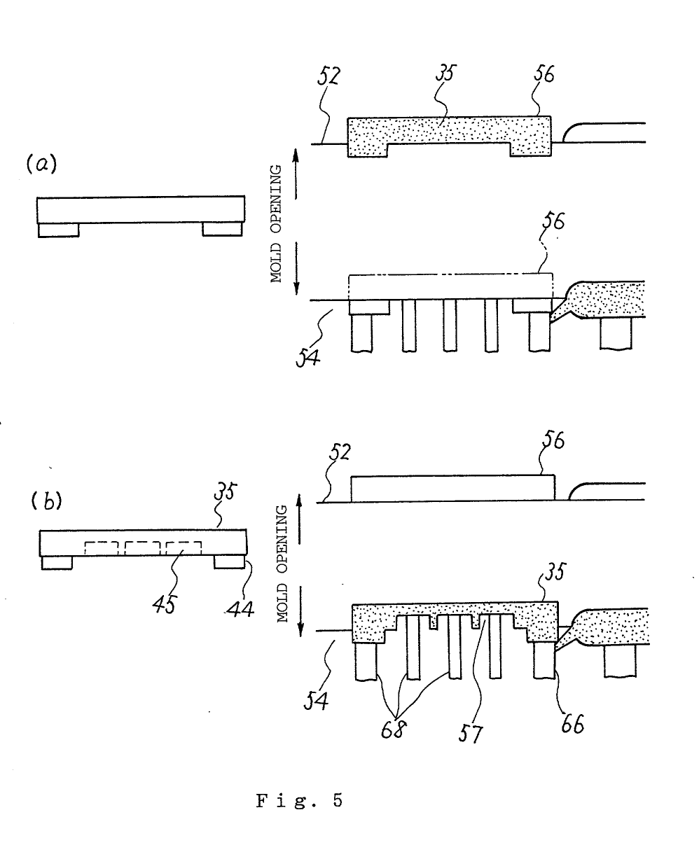

FIG. 1 is a sectional view showing an injection molding apparatus for seal member according to Embodiment 1 of the invention, and is a sectional view taken along the lines I-I of FIG. 2. FIG. 2 is a plan view of top of FIG. 1. FIG. 3 is a sectional view at the time of opening the molds of the injection molding apparatus for seal member shown in FIG. 1. FIGS. 4(a), (b) and (c) are explanatory views, and FIGS. 5(a) and (b) are explanatory views each to explain how to prevent a molding from being taken by a cavity at the time of opening the molds. In these drawings, numeral 51 is an injection molding apparatus for seal member, numeral 52 is a stationary mold, and numeral 53 is a stationary bottom plate of the stationary mold 52. The stationary mold 52 and the stationary bottom plate 53 form a stationary block S. The moving side slidably moves backward and forward (upward and downward in the drawing) in relation to the stationary side. Numeral 54 is a moving mold, and numeral 55 is a backing plate for the moving mold 54. In the stationary mold 52, a cavity 56 (FIGS. 4 and 5) forming all sealing faces 41, 42, 43 of the seal member 35 is formed on mold-carrying face portion thereof. In the mold-carrying face of the moving mold 54, convex portions 57 for recesses 45 of wall thickness and a cavity for protrusions 44 that restrict axial movement of the plate spring 37 are respectively formed.

When mating the moving mold 54 with the stationary mold 52, a cavity 58 for the seal member 35 is formed between both mold-carrying face portions. In the stationary mold 52, a part of the gate 59 is provided at the mold-carrying face and an injection port 60 for injecting a molten resin is provided on the stationary bottom plate 53 on the opposite side of the mold-carrying face. The resin fed from the injection port 60 is charged into the cavity 58 passing through a runner 61 and the gate 59. In the moving mold 54, a part of the gate 59 is formed at the mold-carrying face. End portion of the gate 59 has an opening at a position a little lower than the bottom of the cavity 58 being in contact with the projection 44 of the seal member 35, and communicates to the cavity 58 at the time of feeding the molten resin (FIG. 4).

Numeral 62 is a moving platen provided by interposing a spacer block 63 between itself and the backing plate. Numeral 64 is a first ejector mechanism accommodated in the spacer block 63. The first ejector mechanism 64 has a gate seal pin 66 provided through a second ejector mechanism 65, the backing plate 55 and the moving mold 54. The first ejector mechanism 64 is hydraulically driven (by hydraulic poweer) to slide itself, thereby moving the gate seal pin 66 in ejecting direction. Numeral 67 is an energizing spring that energizes the first ejector mechanism 64 in the opposite direction of the ejecting direction. Numeral 65 is a second ejector mechanism accommodated in the spacer block 63. The second ejector mechanism 65 has a plurality of (six) ejector pins 68 provided through the backing plate 55 and the moving mold 54. The second ejector 64 is hydraulically driven to slide itself, thereby moving the plurality of ejector pins 68 in ejecting direction. Numeral 69 is an energizing spring that energizes the second ejector mechanism 65 in the opposite direction of the ejecting direction. Note that the moving mold 54, backing plate 55, the spacer block 63 and the moving platen 62 form a moving block M.

The gate seal pin 66 is placed at a position where the end portion of the gate 59 is open until resin is injected (FIG. 4(a)) Immediately after the resin is injected (or at the time of initial cooling thereafter), however, the gate seal pin 66 is hydraulically ejected toward the stationary mold 52 (in the direction indicated by the arrow in FIG. 4(b)), and cuts the resin while sealing the opening provided at the end of the gate 59. In FIG. 4, numeral 72 is a mold splitting position between the stationary mold 52 and the moving mold 54.

Molding process is hereinafter described. By moving forward the moving block M of the injection molding apparatus 1 for seal member and by mating the moving mold 54 and the stationary mold 52 together, the two molds are closed. Then a molten resin is injected from the injection port 60 carried on the stationary bottom plate 53 (FIG. 1). After charging the cavity 58 with the injected resin passing through the runner 61 and the gate 59 (FIG. 4a), the first ejector mechanism 64 is hydraulically moved forward in a slidable manner, thereby moving forward the gate seal pin 66. Thus the resin located at the end of the gate seal pin 66 is forcedly pushed and cut while sealing the opening at the end of the gate 59 (FIG. 4b).

Subsequently, after cooling the injected resin (at this time, a resin for the next cycle is measured), the molds are opened by moving the moving block M (FIG. 3) backward and the second ejector mechanism 65 is hydraulically moved forward in a slidable manner together with the first ejector mechanism 64. Accordingly, the seal member 35 just having been molded is ejected by the plurality of ejector pins 68 and the gate seal pin 66, and the resin within the gate 59 is ejected by a ejector pin 68. In this manner, it is possible to take out the seal member 35 that has been separated from the resin within the gate 59 (FIG. 4c). After that, when deactivating the hydraulic power, the second ejector mechanism 65 and the first ejector mechanism 64 restore to their initial positions by the energizing springs 69, 67. As a result, the ejector pins 68 and the gate seal pin 66 also restore to their initial positions.

As illustrated in FIG. 4b, the ejecting positions of the ejector pins 68 (four pieces) and the gate seal pin 66 (one piece) in relation to the seal member 35 being a molding are established other than the sealing faces 41, 42, 43 of the seal member 35. That is, the ejecting positions of the ejector pins 68 (three pieces) are established to be at recesses of wall thickness 45 of the seal member 35. Likewise the ejecting positions of the remaining ejector pin 68 (one piece) and the gate seal pin 66 (one piece) are established to be at the protrusions 44 of the seal member 35. As a result, there is no possibility that any trace of irregularity caused by the ejector pins or the gate seal pin is left on the sealing faces of the seal member 35.

Note that, in this Embodiment, on the mold-carrying face of the moving mold 54, convex portions 57 for forming recesses of wall thickness are formed at portions not serving as the sealing faces of the seal member 35 (FIG. 4c). As a result of such construction, when opening the mold, sliding resistance between the mold-carrying face portion of the moving mold 54 and the seal member 35 molded within the cavity 58 is increased in relation to the mold opening direction. For this reason, when opening the mold carried on the moving block M from the stationary block S (FIG. 5b), sliding resistance of convex portions 57 for recesses of wall thickness in the moving mold 54 is greater than that of the cavity 56 in the stationary mold 52. Consequently, the seal member 35 molded within the cavity 58 is capable of remaining in the cavity of the moving mold 54 without being taken by the cavity 56 of the stationary mold 52. As a result, it is possible to take out the molded seal member 35 therefrom by means of the ejector pins 68 and the gate seal pin 66 in the subsequent process. Note that the seal member 35 is small in wall thickness as a result of forming the recesses of wall thickness 45 in the seal member 35, thus an improvement is achieved in the aspect of moldability.

This advantage is compared with the known construction in which convex portions serving as recesses of wall thickness 57 are not formed on the mold-carrying face portion of the moving mold 54 (FIG. 5a). In this case, contact area between the stationary mold 52 and molded seal member 35 becomes greater than that between the moving mold 54 and molded seal member 35. Therefore, a trouble may occur in that the seal member 35 molded within the cavity 58 is taken out by the cavity 56 of the stationary mold 52, at the time of opening the moving block M from the stationary side block S. Once happened such a trouble, it becomes impossible to take out the molded seal member 35 by means of the ejector pins 68 and the gate seal pin 66 in the subsequent process. This makes it necessary to take out the seal member 35 separately, which affects negatively the continuous production.

The opening at the end portion of the gate 59 is provided on excess thickness of the molding to be a seal member, and the excess thickness is forcedly pushed and removed by the first ejecting of the gate seal pin 66. Therefore, there is no possibility that any gate cut trace remains on the moldings. Moreover, the resin of the gate 59 is cut in the cavity 58 by the first ejecting, and in the second ejecting it is possible to separate molded scraps from the molding.

The end portion for the ejection by the gate seal pin 66 requires a certain strength, and therefore an area at least equivalent to 2φ is required. The gate seal pin may be plate-like or core-like as well.

In this Embodiment 1, the gate seal pin 66 compresses the resin, and accordingly it becomes possible to charge with a resin of high density, and keep a molding shrinkage low. Consequently, the moldings are superior in terms of dimensional stability. Because of this advantage, it is possible to improve shrinkage of resin, SO called thermal shrinkage under the working temperature environment of valve timing adjustment device used in internal combustion engines and the like.

As for resin, nylon or PPS (polyphenylene sulfide plastic resin) is used, for example. In the case that aspect ratio of the seal member's configuration is not more than 4, there hardly arises a problem of warpage in the molding being a seal member. Therefore, it is desirable to provide an opening of the gate at substantially middle part not serving as a sealing face of a molding to be a seal member. If the aspect ratio of the seal member's configuration is not less than four, provision of openings or opening at both end portions or one end portion in longitudinal direction of the molding being a seal member is effective to reduces warpage of the mold. With increasing aspect ratio of the seal member's configuration, there arises a problem of warpage of the molding unless opening of the gate is placed at end portion in longitudinal direction of the molding to be a seal member. Using a low warpage resin, however, reduces this problem. In the case of blending fibrous filler to a resin, provision of openings or opening at both end portions or one end portion in longitudinal direction of the molding to be a seal member reduces the problem of warpage.

Embodiment 2

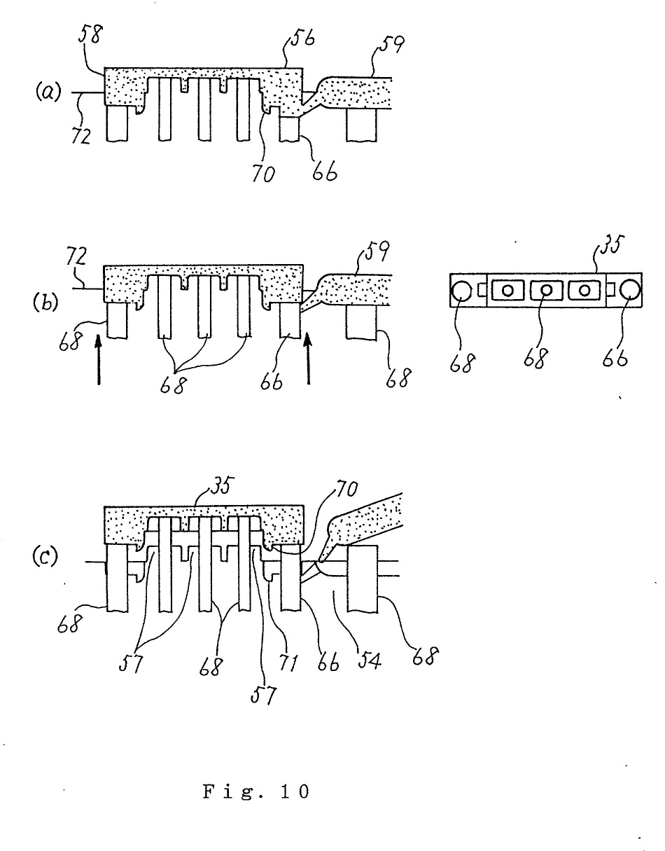

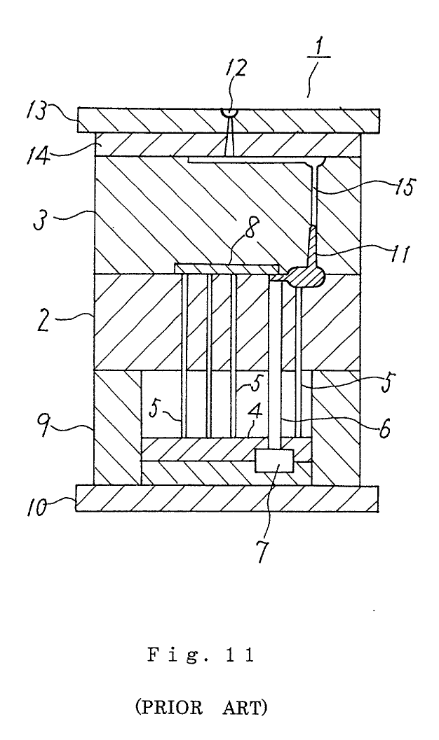

FIGS. 10(a), (b) and (c) are explanatory views each showing a construction of a cavity of an injection molding apparatus for seal member according to Embodiment 2 of the invention, and correspond to FIGS. 4(a), (b) and (c) of. In this Embodiment 2, concave portions 71 where ribs 70 are to be formed are additionally formed at portions not serving as the sealing faces of the seal member 35 (FIG. 10(c)). As a result of such construction, at the time of opening the mold, sliding resistance between the mold-carrying face portion and the seal member 35 molded in the cavity 58 increases in mold opening direction. As a result of such construction, when opening the mold on the moving block M from the stationary block S (FIG. 5b), sliding resistance of concave portions 71 for ribs in the moving mold 54 is greater than that of the cavity 56 in the stationary mold 52. Consequently, the seal member 35 molded in the cavity 58 is capable of remaining in the cavity of the moving mold 54 without being taken by the cavity 56 of the stationary mold 52. As a result, it is possible to take out the molded seal member 35 therefrom by means of the ejector pins 68 and the gate seal pin 66 in the subsequent process.

In this Embodiment 2, although both the convex portions 57 for recesses of wall thickness and the concave portions 71 for ribs are formed in the mold-carrying face of the moving mold 54, it is also preferable to form only the concave portions 71 for ribs.

What is claimed is:

1. An injection molding apparatus for seal member in which
a molten resin is injected byway of a gate into a cavity formed by mating a moving mold with a stationary mold;
the injected resin is cut by means of a gate seal pin provided on the moving side while sealing the gate; and
a seal member left on the movable side is ejected by means of a plurality of ejector pins provided on the moving side under a condition of opening said moving mold from said stationary mold, thereby molding the seal member;
the injection molding apparatus being provided with defined convex portions on said moving mold and the defined convex portions forming recesses of wall thickness at portions not serving as sealing faces of the seal member.

2. The injection molding apparatus for seal member according to claim 1, wherein ejecting position of the ejector pins is adapted to come to the portions not serving as sealing faces of the seal member.

3. The injection molding apparatus for seal member according to claim 2, wherein said gate seal pin performs a function of ejecting the seal member left on the moving side in cooperation with said ejector pins, and ejecting position of said gate seal pin is adapted to come to the portions not serving as sealing faces of the seal member.

4. The injection molding apparatus for seal member according to claim 1, wherein the seal member is adapted to be used in valve timing adjustment devices.

5. An injection molding apparatus for seal member in which
a molten resin is injected by way of a gate into a cavity formed by mating a moving mold with a stationary mold;
the injected resin is cut by means of a gate seal pin provided on the moving side while sealing the gate; and
a seal member left on the movable side is ejected by means of a plurality of ejector pins provided on the moving side under a condition of opening said moving mold from said stationary mold, thereby molding the seal member;
the injection molding apparatus being provided with defined concave portions on said moving mold and the defined concave portions forming ribs at portions not serving as sealing faces of the seal member.

6. The injection molding apparatus for seal member according to claim 5, wherein ejecting position of the ejector pins is adapted to come to the portions not serving as sealing faces of the seal member.

7. The injection molding apparatus for seal member according to claim 6, wherein said gate seal pin performs a function of ejecting the seal member left on the moving side in cooperation with said ejector pins, and ejecting position of said gate seal pin is adapted to come to the portions not serving as sealing faces of the seal member.

8. The injection molding apparatus for seal member according to claim 5, wherein the seal member is adapted to be used in valve timing adjustment devices.
